(19) United States
(12) Patent Application Publication
(10) Pub. No.: US 2001/0016814 A1
(43) Pub. Date: Aug. 23, 2001

(54) Method and device for recognizing predefined keywords in spoken language

(76) Inventor: Alfred Hauenstein, Munchen (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/767,389

(22) Filed: Jan. 23, 2001

Related U.S. Application Data
(63) Continuation of application No. PCT/DE99/01971, filed on Jul. 1, 1999.

(30) Foreign Application Priority Data
Jul. 23, 1998 (DE) 198 33 212.2

(51) Int. Cl. G10L 15/00

(52) U.S. Cl. 704/231

(57) ABSTRACT

A method and a device recognizes predefined keywords in spoken language. The keywords is modeled for the recognition process. Furthermore, a predefined set of filler words is modeled. If a keyword occurs in the spoken language, this keyword is recognized, otherwise no keyword is recognized if correspondence with a filler word is determined in the spoken language.

### CROSS-REFERENCE TO RELATED APPLICATION

This application is a continuation of copending International Application No. PCT/DE99/01971, filed Jul. 1, 1999, which designated the United States.

### BACKGROUND OF THE INVENTION

1. Field of the Invention

The invention relates to a method and a device for recognizing predefined keywords in spoken language with a computer.

A method and a device for voice recognition are known from Hauenstein, A. “Optimierung von Algorithmen und Entwurf eines Prozessors für die automatische Spracherkennung [Optimization of algorithms and design of a processor for automatic voice recognition]” in Lehrstuhl für Integrierte Schaltungen, Technische Universität München [Chair of Integrated Circuits, Technical University of Munich], (Thesis, Jul. 19, 1993), Chapter 2, pp. 13-26; hereinafter “Hauenstein”. Hauenstein also introduces the components involved in the voice recognition system as well as important technologies that are commonly used in voice recognition.

Modeling is understood below to be the simulation of words in a vocabulary that can be accessed by the voice recognition system. A vocabulary comprises keywords and filler words. A keyword is at least a sound that the system for recognizing spoken language is intended to recognize, and this sound is linked in particular to a predefined action. In particular, a sound contains at least one phoneme. In this context, a keyword can also comprise a plurality of words, at least one pause or at least one noise. A filler word designates an acoustic unit that does not correspond to any keyword, for example a word, a noise or a pause.

Systems for recognizing keywords have become known. See Rose, R. C. “Keyword detection in conversational speech utterances using hidden Markov model based continuous speech recognition” Computer, Speech and Language, Vol. 9 (1995), pp. 309-333; hereinafter “Rose”. See also Junkawitsch et al., “A new keyword spotting algorithm with pre-calculated optimal thresholds”, Proc. Intern. Conference on Speech and Language Processing (1996), pp. 2067-2070; hereinafter “Junkawitsch”. Rose and Junkawitsch model only the keywords and/or only phrases from keywords. In order to reject words that are not keywords, algorithms are used which distinguish keywords from the other words. A disadvantage of these systems is that in each case a new configuration of the voice recognition system has to be carried out for a new vocabulary.

Another approach to recognizing keywords is a voice recognition system with a large vocabulary. If such a system recognizes all the words and noises, predefined keywords also can be recognized. See Weintraub, M. “LVCSR Log-Likelihood Ratio Scoring for Keyword-spotting,” in Proc. Intern. Conference on Acoustics, Speech and Signal Processing (1995), pp. 297-300; hereinafter “Weintraub”. Such a system makes extremely high demands of the computing power and is generally not available on the computers provided for voice recognition. In addition, modeling all the acoustic events is virtually impossible.

### SUMMARY OF THE INVENTION

It is accordingly an object of the invention to provide a method and device for recognizing predefined keywords in spoken language that overcome the hereinafore-mentioned disadvantages of the heretofore-known devices of this general type and that minimizes resources required by stopping the recognition of keywords when an inputted word is determined to be a filler word. With the foregoing and other objects in view, there is provided, in accordance with the invention, a method for recognizing a set of predefined keywords in spoken language with a computer. The method includes the following steps: a) predefining a set of filler words; b) modeling a predefined keyword; c) recognizing the keyword occurring in spoken language; d) determining a filler word in the spoken language and not recognizing a keyword; and e) recognizing a predefined set of keywords, the set of keywords taking into account the predefined filler words.

In accordance with another feature of the invention, the predefined set of filler words is smaller than fifty words.

In accordance with another feature of the invention, the predefined set of filler words is determined from a predefined number of most frequently used words of a language.

In accordance with another feature of the invention, the method includes deleting a filler word, which is a keyword, from the set of filler words when the predefined set of keywords changes.

In accordance with another feature of the invention, the method includes deleting a filler word from the set of filler words if the filler word corresponds to a part of a keyword.

In accordance with another feature of the invention, the method includes deleting a filler word from the set of filler words if the filler word is acoustically similar to a part of a keyword.

In accordance with another feature of the invention, the method includes displaying the keywords recognized in the spoken language; and not displaying the recognized filler words.

In accordance with another feature of the invention, the method includes modeling a noise of a language to form a modeled noise; and adding the modeled noise to the set of filler words.

In accordance with another feature of the invention, the method includes modeling a pause to form a modeled pause; and adding the modeled pause to the set of filler words.

In accordance with another feature of the invention, the method includes controlling a medical apparatus with a keyword.

In accordance with another feature of the invention, the method includes predefining actions to be completed by a computer. These actions occur when a keyword is input to the computer.

In accordance with another feature of the invention, the method includes controlling a communications technology with a keyword.

In accordance with another feature of the invention, the method includes controlling an application with a keyword.

In accordance with another feature of the invention, the method includes programming a code word indicating that a keyword follows.

In accordance with another feature of the invention, the code word is modeled as a filler word.

With the objects of the invention in view, there is also provided a device for recognizing at least one set of predefined keywords in spoken language. The invention includes a processor unit. The processor unit is set up in such a way that a) a set of filler words is predefined; b) a predefined keyword is modeled for a recognition process; c) if a keyword is input, this keyword is recognized; d) if correspondence with a member of the set of filler words is determined in the spoken language, no keyword is recognized; and e) another predefined set of keywords can be recognized taking into account the predefined filler words.

In accordance with another feature of the invention, the predefined set of filler words is small.

In accordance with another feature of the invention, the predefined set of filler words is composed from a predefined number of the most frequently used words of a language.

Firstly, a method for recognizing predefined keywords in spoken language is disclosed. In this method, the keywords are modeled for the recognition process. Furthermore, a predefined set of filler words is modeled. If a keyword occurs in the spoken language, this keyword is recognized, otherwise no keyword is recognized if correspondence with a filler word is determined in the spoken language.

A further development of the invention is that the predefined set of filler words is small. This is a decisive advantage because the size of the set of filler words directly affects the computing power of the voice recognition system. Thus, even a computer with relatively small computing power can handle a small set of filler words. In turn, this saving in computing power reduces the costs of the voice recognition system.

Furthermore, the predefined set of filler words is determined from a predefined number of most frequent words of a language.

One advantage of the invention is that, in particular, the set of filler words can be identical for all possible combinations of keywords. Therefore, when the keywords are changed, the set of filler words does not need to be changed. The set of these filler words is used to absorb all the words of the spoken language that are not keywords, that is to say to prevent these “non-keywords” being recognized as keywords. For this purpose, the filler words are preferably short, single-syllable words whose acoustic representations correspond to the words of the spoken language which are not keywords, or at least to parts of these words. In particular, the set of the filler words can be acquired from analyzing spoken dialogs. To do this, a frequency list of the words occurring in these dialogs is determined and the approximately fifteen to fifty (15-50) most frequent words are selected as filler words. Preferably, the filler words are provided with a mark. If a keyword corresponds to a filler word from the set of filler words, this filler word is removed from the set of filler words. Preferably, the keywords and the filler words are subsequently modeled by means of a system for recognizing spoken language. See Hauenstein, A. “Optimierung von Algorithmen und Entwurf eines Prozessors für die automatische Spracherkennung [Optimization of algorithms and design of a processor for automatic voice recognition].” in Lehrstuhl für Integrierte Schaltungen, Technische Universität Munchen [Chair of Integrated Circuits, Technical University of Munich], Thesis, (Jul. 19, 1993), Chapter 3, pp. 27-86; hereinafter “Hauenstein”. All the marked filler words are filtered out of the spoken language and thus only the keywords are displayed to a user or a target application.

A particular advantage is that the system for determining the filler words can be based on a statistical analysis of natural spontaneous language. As a result, words that are actually spoken by a human being are modeled and the filler words give rise to excellent hit rates for non-keywords. It is also a particular advantage that the small set of filler words makes only small demands of the computing power of the computer to be used.

In addition, a combination of the invention with known methods for recognizing keywords is advantageous. This applies in particular to the modeling of noises and pauses. See Rose.

One development of the invention also comprises a filler word being deleted from the set of filler words if this filler word corresponds to part of a keyword.

Another development consists in the keywords recognized in the spoken language being displayed and the recognized filler words not being displayed.

Within the scope of an additional development, at least one noise or at least one pause is modeled and added to the set of filler words.

One possible use of the method according to the invention consists in driving a medical apparatus by means of the keywords.

Another use of the invention is replying to a customer inquiry, in particular in a communications network, for example the telephone network, the customer inquiry being triggered by a keyword. Thus, for example the system replies to a customer call when the customer gives a certain keyword. This permits automated and efficient interaction between the customer and a computer, and a human customer service officer can also be addressed—via a keyword.

Another development of the invention is the determining of a code word that indicates that a keyword follows, preferably directly. One example is to control medical apparatuses during the operation with the code word “Computer”:

“Computer operating table higher” instead of “Operating table higher”.

The code word “Computer” signals to the system for recognizing keywords that subsequently a keyword “Operating table higher” possibly will be uttered. In addition, as a development, the code word “Computer” can be modeled as a filler word so that a keyword is not detected if the code word is uttered by chance without a following keyword.

With the objects of the invention in view, there is also provided a [second independent claim]

A device for recognizing predefined keywords in spoken language is also disclosed that has a processor unit which is set up in such a way that the predefined keywords are modeled for the recognition process. In addition, a predefined set of filler words is modeled. If a keyword occurs in the spoken language, this keyword is recognized, or no keyword is recognized if correspondence with a filler word is determined in the spoken language.

A development of the device according to the invention includes shrinking the predefined set of filler words or determining the predefined set of filler words from a predefined number of the most frequent words of a language.

This device is suitable in particular for carrying out the method according to the invention or one of its developments explained above.

Other features which are considered as characteristic for the invention are set forth in the appended claims.

Although the invention is illustrated and described herein as embodied in a method and device for recognizing predefined keywords in spoken language, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic of a device for recognizing predefined keywords in spoken language;

FIG. 2 shows a flowchart representing a method for recognizing predefined keywords in spoken language;

FIG. 3 shows a flowchart representing a method for determining the filler words;

FIG. 4 is a list with possible filler words; and

FIG. 5 shows a processor unit.

### DESCRIPTION OF THE PREFERRED EMBODIMENTS

In all the figures of the drawing, sub-features and integral parts that correspond to one another bear the same reference symbol in each case.

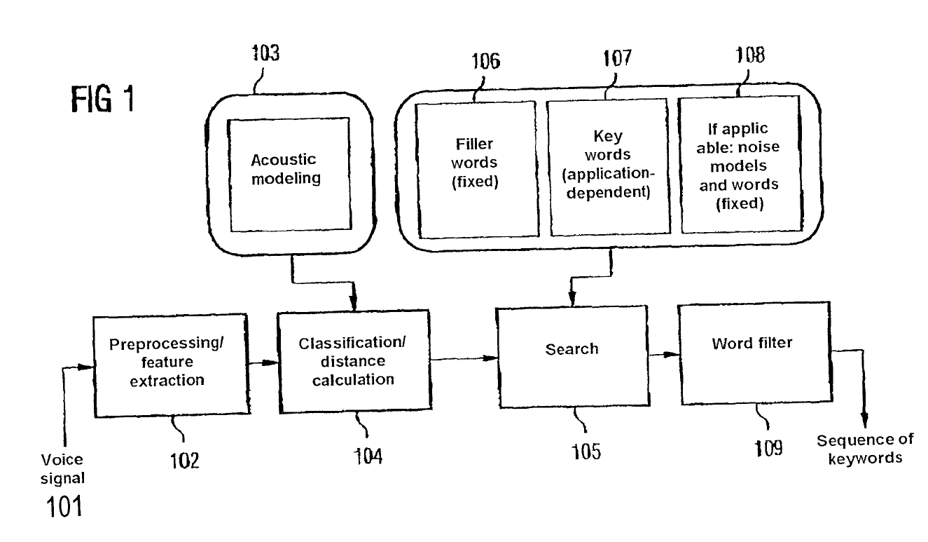

Referring now to the figures of the drawings in detail and first, particularly to FIG. 1 thereof, there is shown a schematic view of a voice recognition system.

The precondition for the recognition of naturally spoken language is a suitable formalism of the representation of knowledge. A complete voice recognition system includes a plurality of processing levels. These processing levels are, in particular, acoustics/phonetics, intonation, syntax, semantics and pragmatics. The processing levels for the recognition of keywords are shown in FIG. 1.

The natural language signal 101 is fed into the voice recognition system. There, a feature extraction is carried out in a component 102. After the feature extraction, classification 104 (also referred to as distance calculation) of the features of the language signal 101 that are acquired in the preprocessing 102 is carried out by means of acoustic modeling 103. The classification 104 is followed by a search 105 for predefined filler words 106, application-specific keywords 107 or predefined noise models 108 (optionally also modeling of pauses is possible). The relationships 106, 107 and/or 108 are established with the search 105 and are filtered in a logic block 109. The resulting sequence of keywords 110 is output.

It is to be noted that the block structure in FIG. 1 merely represents a logical structuring possibility. An implementation in hardware or software components is not restricted to the structure illustrated in FIG. 1.

FIG. 2 shows a block diagram that illustrates a method for recognizing predefined keywords in spoken language. For this purpose, the keywords are modeled in a step 201. The filler words are modeled in a step 202. Then, in a step 203 the components of the spoken language (sounds) are divided into keywords and filler words. The keywords that are found are displayed in a step 204.

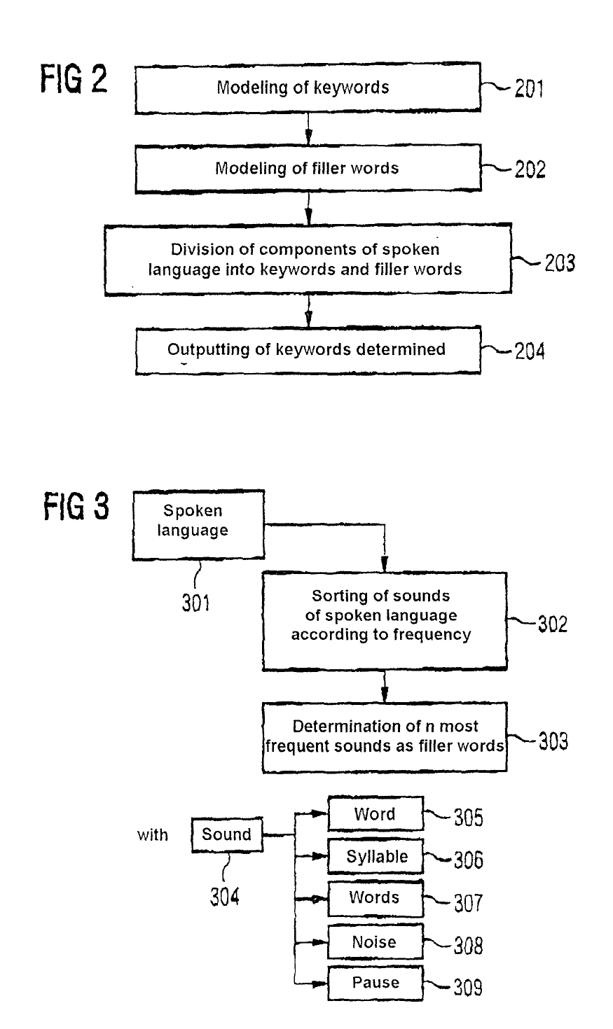

FIG. 3 shows a block diagram that represents a possible way of determining the filler words. For this purpose, the spoken language 301 is decomposed into sounds (components), and these sounds are sorted according to their frequency (see step 302).

In a step 303, the n most frequent sounds are determined as filler words. A sound 304 is in particular a word 305, a syllable 306, a plurality of words 307, a noise 308, or a pause 309.

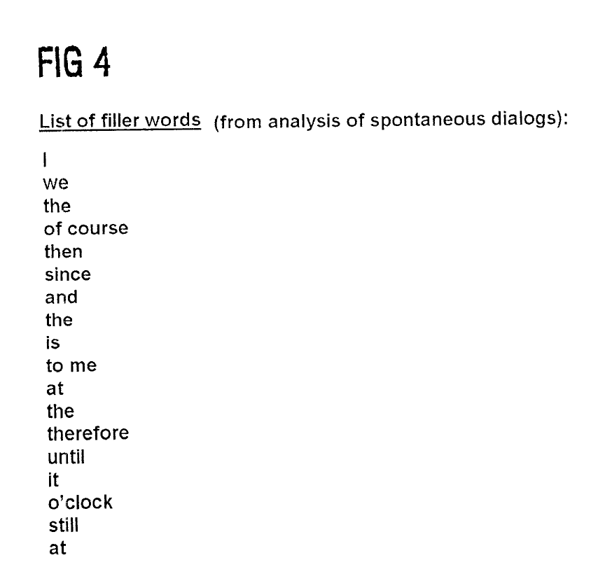

FIG. 4 shows a list with possible filler words. The filler words occur frequently in natural language dialogs in the modeled language (for example German) and are outstandingly suitable for modeling non-keywords. FIG. 4 shows by way of example a list with 18 filler words:

“I—we—the—of course—then—since—and—the— is—to me—at—the—therefore—until—it—o'clock—still—at”

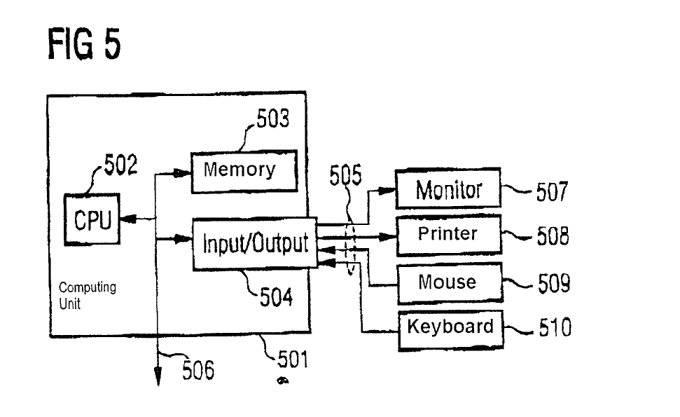

FIG. 5 illustrates a computing unit 501. The computing unit 501 includes a processor CPU 502, a memory 503, and an input/output interface 504. The input/output interface 504 is used in different ways by an interface 505 that extends out of the computing unit 501. An output can be viewed on a monitor 507 with a graphic interface and/or is output on a printer 508. A mouse 509 or a keyboard 510 accomplishes inputting. The computing unit 501 also has a bus 506 that ensures the connection of memory 503, processor 502 and input/output interface 504. In addition, additional components can connect to the bus 506. These additional components include, but are not limited, to additional memory and, hard disks. The interface 505 or the bus 506 can drive external apparatuses or another program running on another computer.

I claim:

1. A method for recognizing a set of predefined keywords in spoken language with a computer, which comprises:
a) predefining a set of filler words;
b) modeling a predefined keyword;
c) recognizing the keyword occurring in spoken language;
d) determining a filler word in the spoken language and not recognizing a keyword; and
e) recognizing a predefined set of keywords, the set of keywords taking into account the predefined filler words.

2. The method according to claim 1, wherein the predefined set of filler words is smaller than fifty words.

3. The method according to claim 1, wherein the predefined set of filler words is determined from a predefined number of most frequently used words of a language.

4. The method according to claim 1, including:
deleting a filler word, which is a keyword, from the set of filler words when the predefined set of keywords changes.

5. The method according to claim 1, including:
deleting a filler word from the set of filler words if the filler word corresponds to a part of a keyword.

6. The method according to claim 1, including:
deleting a filler word from the set of filler words if the filler word is acoustically similar to a part of a keyword.

7. The method according to claim 1, including:
displaying the keywords recognized in the spoken language; and
not displaying the recognized filler words.

8. The method according to claim 1, including:
modeling a noise of a language to form a modeled noise; and
adding the modeled noise to the set of filler words.

9. The method according to claim 1, including:
modeling a pause to form a modeled pause; and
adding the modeled pause to the set of filler words.

10. The method according to claim 1, including:
controlling a medical apparatus with a keyword.

11. The method according to claim 1, including:
predefining actions to be completed by a computer, the actions occurring when a keyword is input to the computer.

12. The method according to claim 1, including:
controlling a communications technology with a keyword.

13. The method according to claim 1, including:
controlling an application with a keyword.

14. The method according to claim 1, including:
programming a code word indicating that a keyword follows.

15. The method according to claim 14, wherein the code word is modeled as a filler word.

16. A device for recognizing at least one set of predefined keywords in spoken language, comprising:
a processor unit programmed to
a) predefine a set of filler words;
b) model a predefined keyword for a recognition process;
c) recognize a keyword if the keyword is input;
d) recognize no keyword if correspondence with a member of the set of filler words is determined in the spoken language; and
e) recognize another predefined set of keywords taking into account the predefined filler words.

17. The device according to claim 16, wherein the predefined set of filler words is small.

18. The method according to claim 14, wherein the predefined set of filler words is composed from a predefined number of the most frequently used words of a language.
